(19) United States
(12) Patent Application Publication
(10) Pub. No.: US 2013/0250228 A1
(43) Pub. Date: Sep. 26, 2013

(54) LCD Panel, Manufacturing Method Thereof, and LCD Device

(71) Applicants: Chiachiang Lin, Shenzhen (CN); Hunglung Hou, Shenzhen (CN)

(72) Inventors: Chiachiang Lin, Shenzhen (CN); Hunglung Hou, Shenzhen (CN)

(21) Appl. No.: 13/512,674

(22) PCT Filed: Mar. 31, 2012
(86) PCT No.: PCT/CN2012/073396

§ 371 Date: May 30, 2012

(30) Foreign Application Priority Data
Mar. 26, 2012 (CN) 201210082602.7

(51) Int. Cl. G02F 1/1339; H01J 9/24

(52) U.S. Cl. 349/156; 349/155; 445/24

(57) ABSTRACT

The invention provides an LCD panel, a manufacturing method thereof, and an LCD device. The LCD panel comprises a first substrate and a second substrate which are oppositely arranged in a mode of one above and one below, and a spacer arranged between the first substrate and the second substrate; wherein, the spacer comprises a first spacer, and a second spacer; one end of the first spacer is arranged on the first substrate, the second substrate is provided with a groove in the position corresponding to the first spacer, the other end of the first spacer is positioned above the top plane of the groove, and both ends of the second spacer are respectively arranged on the first substrate and the second substrate. Because the groove is designed on the second substrate of the LCD panel, the first spacer is positioned above the groove. When pressure is applied to the LCD panel by external force, the first spacer enters the groove under the action of the external force, the groove limits the first space to horizontally move, thereby avoiding a dark area formed by reducing the thickness of the local area of the LCD panel when the second spacer horizontally moves.

### TECHNICAL FIELD

The invention relates to the field of liquid crystal displays (LCDs), and more particularly to an LCD panel, a manufacturing method thereof, and an LCD device.

### BACKGROUND

As a crucial component of an LCD device, an LCD panel is an indispensable part for the LCD device to display images.

As shown in FIG. 1, an LCD panel includes a thin film transistor (TFT) substrate 100, a color film (CF) substrate 200; liquid crystal molecules are filled between the TFT substrate 100 and the CF substrate 200. A first spacer 220 and a second spacer 230 for support are also arranged between the TFT substrate 100 and the CF substrate 200, thereby keeping the thickness of the LCD panel.

As shown in FIG. 1, the first spacer 220 and the second spacer 230 are arranged on the CF substrate 200, wherein a gap is formed between the first spacer 220 and the TFT substrate 100, namely the first spacer 220 is not in contact with the TFT substrate 100, but the second spacer 230 is in contact with a second insulating layer 120 of the TFT substrate 1001. The second spacer 230 is a crucial component for keeping the thickness of the LCD panel, the first spacer 220 is mainly used for making the LCD panel have the function of buffer to offset the external force when the LCD panel is extruded by the external force, avoiding the phenomenon that the display effect of the LCD panel is affected because oversize unrecoverable deformation is caused to the LCD panel. The height of the first sparer 220 is equal to that of the second spacer 230; thus, the corresponding position of the lower end of the second spacer 230 is provided with a protrusion on one side of the TFT substrate 100, to enable the second spacer 230 to be in contact with the second insulating layer 120 of the TFT substrate 100, and then achieving the purpose of support to enable the thickness of the LCD panel to be kept. However, when being extruded by external force, another case may occur in the LCD panel: the second spacer 230 may deviate from the protrusion when being extruded by external force, resulting in that the second spacer 230 has no supporting point or the supporting point is in low position; thus, the thickness of the extruded LCD panel is reduced; therefore, a dark area is formed because the light transmittance is reduced, and then the display effect of the LCD device is affected.

### SUMMARY

In view of the above-described problems, the aim of the invention is to provide an LCD panel and a manufacturing method thereof with good extrusion resistance, and an LCD device.

The aim of the invention is achieved by the following technical scheme. An LCD panel comprises a first substrate and a second substrate which are oppositely arranged in a mode of one above and one below, and a spacer arranged between the first substrate and the second substrate; wherein, the spacer comprises a first spacer, and a second spacer; one end of the first spacer is arranged on the first substrate, the second substrate is provided with a groove in the position corresponding to the first spacer, the other end of the first spacer is positioned above the top plane of the groove, and both ends of the second spacer are respectively arranged on the first substrate and the second substrate. The height of the first spacer is equal to that of the second spacer, the second substrate is provided with a protrusion in the position corresponding to the second spacer, and the lower end of the second spacer is arranged on the protrusion. The groove is formed by etching one or more material layers of the second substrate.

The invention further includes a second technical scheme: an LCD panel comprises a first substrate and a second substrate which are oppositely arranged in a mode of one above and one below, and a spacer arranged between the first substrate and the second substrate; wherein, the spacer comprises a first spacer, and a second spacer; one end of the first spacer is arranged on the first substrate, the second substrate is provided with a groove in the position corresponding to the first spacer, the other end of the first spacer is positioned above the top plane of the groove, and both ends of the second spacer are respectively arranged on the first substrate and the second substrate.

Preferably, the height of the first spacer is equal to that of the second spacer, thereby facilitating the arrangement of the spacers. The spacers of the same height are directly formed on the substrate, and the spacer(s) is divided into a first spacer and a second spacer as required, achieving the effect of simplifying process.

Preferably, the second substrate is provided with a protrusion in the position corresponding to the second spacer, and the lower end of the second spacer is arranged on the protrusion. Because the surface of the second substrate is provided with various lines and material layers, the surface layer is not flat. The protrusion is arranged to enable the first substrate to have corresponding supporting point to the second spacer when the first substrate and the second substrate are pressed, avoiding the occurrence of local protrusion after pressing.

Preferably, the groove is formed by etching one or more material layers of the second substrate. Because the second substrate is provided with one or more material layers, parameters such as the position, the depth, etc. of the groove can be determined as required, and the groove can be formed in the corresponding position of the material layer by etching, thereby having simple and convenient process.

Preferably, the groove is formed by etching the insulating layer of the second substrate. Because the second substrate is usually covered with an insulating layer, the functions of other material layers will not be affected if the groove is etched on the insulating layer.

Preferably, the bottom of the groove is provided with a metal layer, and the metal layer of the bottom of the groove is provided with an etch resistant layer. When the groove is etched on the substrate with a metal layer, an etch resistant layer is arranged on the metal layer before the insulating layer is formed, to avoid affecting the function of the metal layer during etching.

Preferably, the etch resistant layer is an indium tin oxide (ITO) layer. Besides the function of etch resistance, the ITO layer has the function of being used as an electrode, namely the electrode is used as an etch resistant layer, and then the additional process is reduced.

Preferably, the lower end of the first spacer is a buffer section, the upper end of the first spacer is a support section, the buffer section enters the groove when being pressed, and the cross section of the support section is more than that of an opening of the groove. Because of the process reason, the first spacer is of a trapezoid structure, the size of the opening of the groove 140 just makes the smaller part of the lower end of the first spacer 220 enter the groove 140, a part of the lower end of the first spacer 220 does not continue to sink or needs applying larger force to sink after entering the groove 140 until the back of the support section is clamped with the groove 140; thus, the damage to the LCD panel because the substrate is greatly deformed because of oversize external force can be avoided, and the first spacer cannot have overmuch gap for slide after the first spacer is clamped with the groove 140.

A manufacturing method of the aforementioned LCD panel, comprising the following steps:

Forming a first spacer and a second spacer on the first substrate of the LCD panel; and

Forming a groove on the second substrate of the LCD panel in the position of corresponding to the first spacer.

Preferably, the step of forming a groove on the second substrate of the LCD panel in the position corresponding to the first spacer further comprises the steps: forming an insulating layer on the substrate, and forming a groove on the insulating layer.

Preferably, in the step of forming the insulating layer on the substrate and forming the groove on the insulating layer, an ITO layer is formed on the substrate before forming the insulating layer on the substrate.

An LCD device comprises the aforementioned LCD panel.

In the invention, because the groove is designed on the second substrate of the LCD panel, the first spacer is positioned above the top of the groove. When pressure is applied to the LCD panel by external force, the first spacer enters the groove under the action of the external force, the groove limits the first spacer to horizontally move, and correspondingly, the second spacer cannot horizontally move because of being limited by the first spacer, thereby avoiding a dark area formed by reducing the thickness of the local area of the LCD panel because pressure is applied to the second spacer by external force and then the second spacer horizontally moves out the underlayer thereunder, and increasing the pressure resistance of the LCD panel; meanwhile, because the first spacer is positioned on the top plane of the groove but is not positioned in the groove, when the first substrate and the second substrate are pressed, the local protrusion of the LCD panel because the individual first spacer does not correspond to the groove resulted from the process defect can be avoided.

### BRIEF DESCRIPTION OF FIGURES

FIG. 1 is a simplified structure diagram of a conventional LCD panel;

FIG. 2 is a simplified structure diagram of an LCD panel of an example of the invention;

FIG. 3 is another simplified structure diagram of an LCD panel of an example of the invention; and

FIG. 4 is a schematic diagram of an LCD panel of an example of the invention when being pressed.

Wherein: 100. TFT substrate; 200. CF substrate; 110. first insulating layer; 120. second insulating layer; 130. metal layer; 131. ITO layer; 140. groove; 210. photoresistor; 220. first spacer; 230. second spacer; 300. electrode.

### DETAILED DESCRIPTION

The invention will further be described in detail in accordance with the figures and the preferred examples.

The LCD panel of the LCD device of the invention comprises a first substrate and a second substrate which are oppositely arranged in a mode of one above and one below, and a spacer arranged between the first substrate and the second substrate; wherein, the spacer comprises a first spacer, and a second spacer; one end of the first spacer is arranged on the first substrate, the second substrate is provided with a groove in the position corresponding to the first spacer, the other end of the first spacer is positioned above the top plane of the groove, and both ends of the second spacer are respectively arranged on the first substrate and the second substrate. Wherein, the first substrate can be the TFT substrate or the CF substrate of the LCD panel; similarly, the second substrate can be the TFT substrate or the CF substrate of the LCD panel.

FIG. 2 shows a first example of the invention. The LCD panel of the LCD device comprises a TFT substrate 100 and a CF substrate 200 which are oppositely arranged in a mode of one above and one below; liquid crystal molecules are filled between the TFT substrate 100 and the CF substrate 200; Photoresistor(s) 210, the first spacer 220 and the second spacer 230 are respectively arranged on the CF substrate 200, a gap G is reserved between the lower end of the first spacer 220 and the TFT substrate 100, the lower end of the second spacer 230 is in contact with the TFT substrate 100, the thickness of the LCD panel is kept via the second spacer 230, and the first spacer 220 is used for providing a buffer space when pressure is applied to the LCD panel by external force. Therefore, the first spacer 220 and the second spacer 230 are arranged in the LCD panel in accordance with certain rules.

The TFT substrate 100 is provided with a groove 140 in the position corresponding to the lower end of the first spacer 220, the lower end surface of the first spacer 220 is positioned above the top of the groove 140, and the gap G between the first spacer 220 and the TFT substrate 100 is the distance between the bottom of the groove 140 and the lower end surface of the first spacer 220. Because the first spacer 220 is positioned above the top of the groove 140 but is not positioned in the groove 140, when the TFT substrate 100 and the CF substrate 200 are pressed, the local protrusion of the LCD panel because the individual first spacer does not correspond to the groove 140 resulted from the process defect can be avoided. The height of the first spacer 220 is equal to that of the second spacer 230, and the lower end of the second spacer 230 is in contact with the protrusion 150 of the TFT substrate 100. The protrusion 150 is formed by a metal layer 130, a first insulating layer 110, and a second insulating layer 120. The height of the protrusion 150 is higher than that of other material layers of the TFT substrate 100, when the TFT substrate 100 and the CF substrate 200 are pressed, the local protrusion of the LCD panel because the individual second spacer does not correspond to the protrusion resulted from the process defect can be avoided; in addition, compared with the prior art, the protrusion 150 is not required to be very high because the groove 140 provides a sufficient gap G, thereby omitting several processes of forming material layers on the protrusion 150. Of course, the insulating layer of some TFT substrates 100 is not the upmost layer, all the possibly needed material layers such as the flat layer, the electrode layer, etc. can exist. The groove 140 is obtained by etching the material layer of the TFT substrate 100.

Take the TFT substrate 100 using the upper surface as an insulating layer as an example, as shown in FIG. 2, the upper surface of the TFT substrate 100 is formed with various material layers including metal layers 130, first insulating layers 110, second insulating layers 120, and electrode layers 300; the second spacer 230 is in contact with the second insulating layer 120 of the TFT substrate 100, to support the LCD panel to keep the thickness thereof. Because the height of the first spacer 220 is equal to that of the second spacer 230, it is necessary to remove the insulating layer at the lower end thereof to enable a gap G to be kept between the first spacer 220 and the TFT substrate 100. In the example, the groove 140 is formed by etching the insulating layer (including the first insulating layer 110 and the second insulating layer 120) of the TFT substrate 100, and then the gap G is formed; furthermore, in addition to forming the gap G to buffer the applied external force, the groove 140 also has another function: namely when the LCD panel is applied with external pressure to enable the spacer (including the first spacer 220 and the second spacer 230) to horizontally move, the first spacer 220 cannot horizontally move or can only horizontally move within a small range because of being limited by the groove 140, and the second spacer 230 also cannot horizontally move or can only horizontally move within a small range because of being limited by the first spacer 220; thus, the second spacer 230 deviates from the contact layer thereunder because of horizontal moving under the action of external force can be avoided, the problem that the thickness at the second spacer 230 is reduced can be avoided, and the pressure resistance of the LCD panel can be increased.

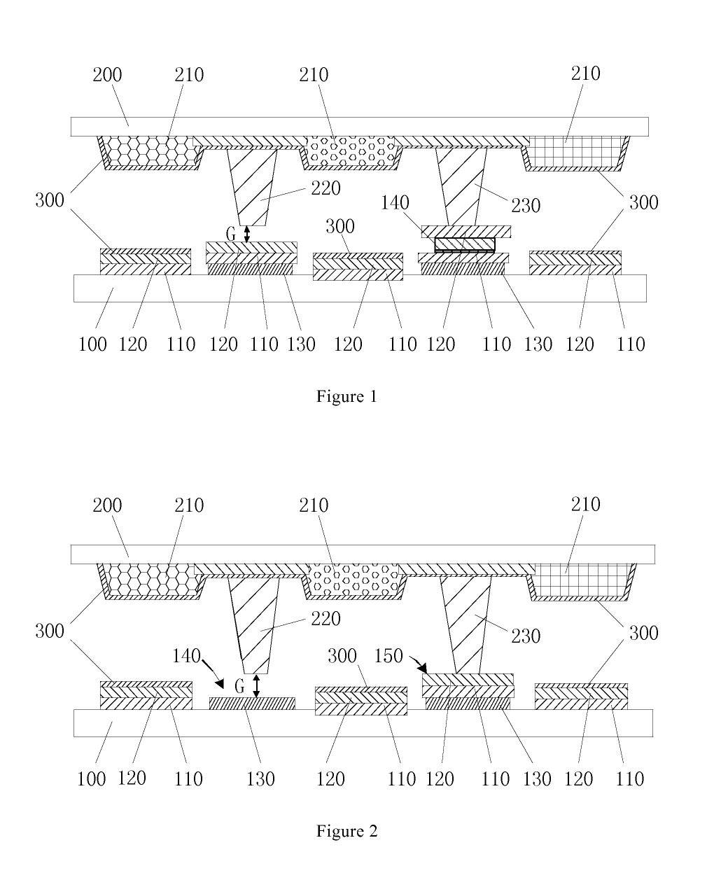

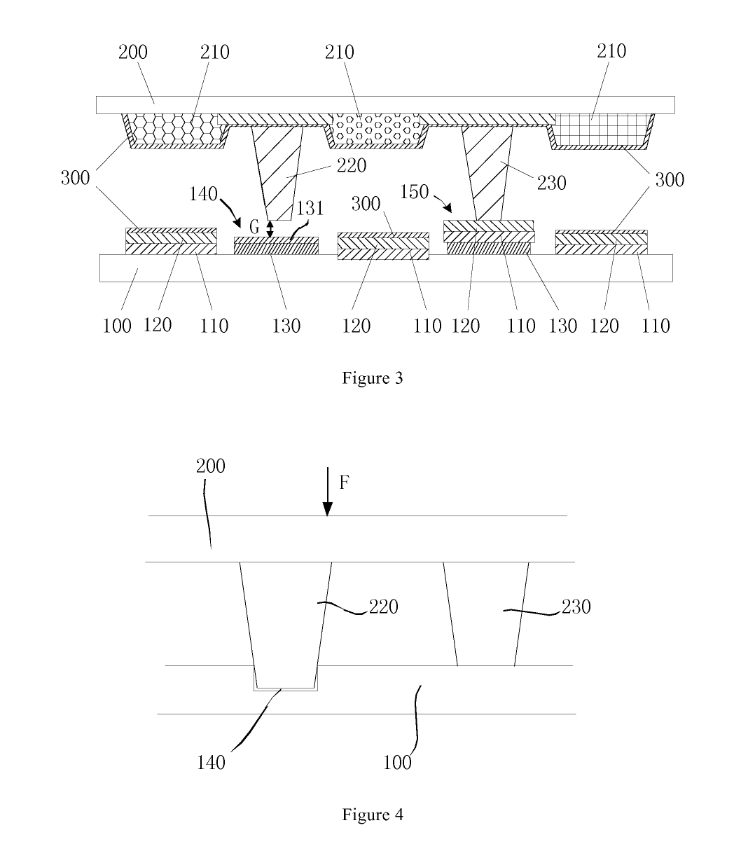

As mentioned above, the height of the first spacer 220 of the example is equal to that of the second spacer 230, aiming to conveniently arrange the spacers. Just the spacers of the same kind are arranged on the CF substrate 200. It is only necessary to consider how to design the groove 140 at the lower end of the first spacer 220 and the underlayer at the lower end of the second spacer 230 on the TFT substrate 100. As shown in FIG. 2 and FIG. 3, compared with the LCD panel shown in FIG. 1, the protrusion 140 at the lower end of the second spacer 230 in the example is also removed, thereby reducing the process of forming the protrusion 140.

To make the lower end of the first spacer 220 successfully enter the groove 140 when the first spacer 220 is pressed, the size of the groove 140 should be more than that of the lower end of the first spacer 220. In addition, as shown in FIG. 4, because of the process reason, the first spacer 220 is of a trapezoid structure in general, the size of the opening of the groove 140 just makes the smaller part of the lower end of the first spacer 220 enter the groove 140. When the LCD panel is pressed by oversize force F, a part of the lower end of the first spacer 220 of a trapezoid structure does not continue to sink or needs applying larger force to sink after entering the groove 140, and the edge of the groove 140 limits the first spacer 220 of a trapezoid structure to continue to sink, i.e. the first spacer 220 is provided with two sections of different function because of the trapezoidal structure thereof, namely the section entering the groove 140 under the action of external force is the buffer section which is used for buffering external pressure, and the section which does not enter the groove 140 is the support section which is used for providing support when the external pressure is oversize when the support section is limited by the edge of the groove 140 and then cannot continue to sink to enter the groove 140 or needs larger force to continue to enter the groove 140, thereby avoiding the damage to the LCD panel because the substrate (the substrate in the example is the CF substrate) is greatly deformed because of oversize external force.

As shown in FIG. 3, because the groove 140 is formed by etching, an etch resistant layer can be formed under the insulating layer before forming the insulating layer; in the example, an ITO layer is formed before forming the insulating layer, to avoid damaging the lower metal layer 130 in the process of etching.

The spacer of the example of the invention comprises a first spacer 220, and a second spacer 230, and is made of resin material which is frequently used and has low cost; to improve the light transmittance of the LCD panel, the spacer is preferably made of resin material with good photonasty.

In addition, it is necessary to provide a manufacturing method of the LCD panel of the invention. Take the LCD panel of the aforementioned example as an example, the manufacturing method of the aforementioned LCD panel comprises the following steps:

Forming a first spacer and a second spacer on the first substrate of the LCD panel; and

Forming a groove on the second substrate of the LCD panel in the position corresponding to the first spacer.

Specifically, the step of forming the groove in the position of the second substrate of the LCD panel corresponding to the first spacer further comprises the steps: forming an insulating layer on the substrate, and forming a groove on the insulating layer.

To avoid affecting the material of the lower layer in the process of etching, in the step of forming the insulating layer on the substrate and forming the groove on the insulating layer, an ITO layer is formed on the substrate before forming the insulating layer on the substrate.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD panel, comprising: a first substrate and a second substrate which are oppositely arranged in a mode of one above and one below, and a spacer arranged between said first substrate and said second substrate; wherein, said spacer comprises a first spacer, and a second spacer; one end of said first spacer is arranged on said first substrate, said second substrate is provided with a groove in the position corresponding to said first spacer, the other end of said first spacer is positioned above the top plane of said groove, and both ends of said second spacer are respectively arranged on said first substrate and said second substrate; the height of said first spacer is equal to that of said second spacer, said second substrate is provided with a protrusion in the position corresponding to said second spacer, and the lower end of said second spacer is arranged on said protrusion; said groove is formed by etching one or more material layers of said second substrate.

2. An LCD panel, comprising: a first substrate and a second substrate which are oppositely arranged in a mode of one above and one below, and a spacer arranged between said first substrate and said second substrate; wherein, said spacer comprises a first spacer, and a second spacer; one end of said first spacer is arranged on said first substrate, said second substrate is provided with a groove in the position corresponding to said first spacer, the other end of said first spacer is positioned above the top plane of said groove, and both ends of said second spacer are respectively arranged on said first substrate and said second substrate.

3. The LCD panel of claim 2, wherein the height of said first spacer is equal to that of said second spacer.

4. The LCD panel of claim 3, wherein said second substrate is provided with a protrusion in the position corresponding to said second spacer, and the lower end of said second spacer is arranged on said protrusion.

5. The LCD panel of claim 2, wherein said groove is formed by etching one layer or more material layers of said second substrate.

6. The LCD panel of claim 5, wherein said groove is formed by etching the insulating layer of said second substrate.

7. The LCD panel of claim 6, wherein the bottom of said groove is provided with a metal layer, and the metal layer of the bottom of said groove is provided with an etch resistant layer.

8. The LCD panel of claim 7, wherein said etch resistant layer is an ITO layer.

9. The LCD panel of claim 2, wherein the lower end of said first spacer is a buffer section, the upper end of said first spacer is a support section, said buffer section enters the groove when being pressed, and the cross section of said support section is more than that of an opening of said groove.

10. A manufacturing method of the LCD panel, comprising: the following steps:
Forming a first spacer and a second spacer on the first substrate of the LCD panel; and
Forming a groove on the second substrate of the LCD panel in the position corresponding to said first spacer.

11. The manufacturing method of the LCD panel of claim 10, wherein said step of forming the groove on the second substrate of said LCD panel in the position corresponding to said first spacer further comprises the steps: forming an insulating layer on said substrate, and forming a groove on said insulating layer.

12. The manufacturing method of the LCD panel of claim 10, wherein in the step of forming the insulating layer on said substrate and forming the groove on said insulating layer, an ITO layer is formed on said substrate before forming said insulating layer on said substrate.

13. An LCD device, comprising: an LCD panel; said LCD panel comprises a first substrate and a second substrate which are oppositely arranged in a mode of one above and one below, and a spacer arranged between said first substrate and said second substrate; wherein, said spacer comprises a first spacer, and a second spacer; wherein one end of said first spacer is arranged on said first substrate, a groove is arranged on said second substrate in the position corresponding to said first spacer, the other end of said first spacer is positioned above the top plane of said groove, and both ends of said second spacer are respectively arranged on said first substrate and said second substrate;

14. The LCD device of claim 13, wherein the height of said first spacer is equal to that of said second spacer.

15. The LCD device of claim 14, wherein said second substrate is provided with a protrusion in the position corresponding to said second spacer, and the lower end of said second spacer is arranged on said protrusion.

16. The LCD device of claim 13, wherein said groove is formed by etching one or more material layers of said second substrate.

17. The LCD device of claim 16, wherein said groove is formed by etching the insulating layer of said second substrate.

18. The LCD device of claim 17, wherein the bottom of said groove is provided with a metal layer, and the metal layer of the bottom of said groove is provided with an etch resistant layer.

19. The LCD device of claim 18, wherein said etch resistant layer is an ITO layer.

20. The LCD device of claim 13, wherein the lower end of said first spacer is a buffer section, the upper end of said first spacer is a support section, said buffer section enters the groove when being pressed, and the cross section of said support section is more than that of an opening of said groove.
